(19) United States
(12) Patent Application Publication
(10) Pub. No.: US 2007/0280073 A1
(43) Pub. Date: Dec. 6, 2007

(54) AUTHENTICATING POLYMERIC FILM

(75) Inventor: Richard H. Selinfreund, Terre Haute, IN (US)

Correspondence Address: KELLEY DRYE & WARREN LLP, 400 ALTLANTIC STREET , 13TH FLOOR, STAMFORD, CT, 06901, US

(73) Assignee: Verification Technologies, Inc., Essex, CT (US)

(21) Appl. No.: 11/755,690

(22) Filed: May 30, 2007

Related U.S. Application Data
(60) Provisional application No. 60/803,500, filed on May 30, 2006.

(51) Int. Cl. G11B 19/04

(52) U.S. Cl. 369/53.21

(57) ABSTRACT

A piracy protection digital recording medium comprising an optical recording medium coated with a polymeric film containing authentication state change material therein, the authentication state change material being readable by a digital reader of such optical recording medium.

### CROSS-REFERENCE TO RELATED APPLICATIONS

This application claims benefit of U.S. Provisional patent application Ser. No. 60/803,500, filed May 30, 2006, the contents of which is incorporated by reference herein in its entirety.

### BACKGROUND OF THE INVENTION

1. Field of the Invention

The present invention generally relates to the protection of data recording media by associating the medium with a polymeric film having authenticating materials thereon.

2. Description of the Related Art

The development of many types of transportable digital storage media which contain stored digital data has burgeoned over the past thirty years. Such digital storage media include such well known items as compact discs, digital video discs, blue-ray discs, memory sticks, optical and non-optical digital memory cards. Such storage media may be passive (such as a typical CD disc) or active, such as a digital memory card containing a processor, for example, the so-called “Smart Card.”

As data stored on such transportable digital storage media may be valuable in its own right, there has been substantial resources applied to illicitly obtaining such data from authorized digital storage media and recording such data on non-authorized digital storage media. Unfortunately, with most traditional transportable digital recording media, extraction of the data from the transportable storage media is possible anywhere in its distribution chain or at any point in which it is read. The extraction of data from such media may not only result in the loss of a potential sale of one or more copies of the authorized media, but in the cases of security cards, such as digital keycard or financial Smart Card security cards, may allow unauthorized persons to gain illicit access to otherwise secured information or locations.

Typical CDs and DVDs are use a single layer of lacquer (“hardcoat”) over the reflective data backing (on the label side) to protect against damage. Blu-ray discs which store more data per layer (e.g. 25 gigabytes v. 15 gigabytes) instead of lacquer employ a clear polymer coating to provide protection from scratching and other types of damage. One such coating known as “Durabis” is available form TDK Corporation. Polycarbonate film such as EUROPLEX PC, having a thickness ranging from about 30 μM to 100 μM has been applied to Blu-Ray discs as well. Such film may demonstrate excellent dimensional stability (skew resistance), low bifringence if IR matched to the polycarbonate substrate onto which it is placed, and high impact strength.

There is a need for an improved technique for reducing the theft of transportable digital recording media, and the content of such transportable digital recording media.

### DEFINITIONS

ABS:=Acrylonitrile butadiene styrene, a plastic material formed through injection molding, used for some smart cards.

Access Control Card: Magnetic or chip cards with or without photo used to enter restricted areas eg. ID badges.

Blank Cards: Cards with no printing usually used in imagining machines.

Chip: A piece of silicon etched with an electronic circuit.

Coercivity: A measure of the strength of a magnetic field. Fields are expressed as low or high by the terms LoCo and HiCo.

Combi-card: A card holding both contact and contactless technology.

Smart-Card Contact: A point of electrical connection between a smart card and its external interface device.

Contact Card: Any data storage card wherein information is transferred to a reader via a series of contact points located on the card.

Contactless Card: A card that contains one or more semiconductor chip and which transfers data using radio frequency technology via a transmitter and receiver.

Degaussing: Magnetic stripe data erasure.

Digital Datum Indicia: an indicium or indicia on a Digital Recording Medium corresponding to a digital data read. Such indicia include optical pits and lands on an optical recording medium, electromagnetically altered portions on a floppy drive, recording dyes altered for digital read, punctuate indicia representative of a data read.

Digital Reader: any device capable of detecting and reading digital information that has been recorded on an Digital Recording Medium. By the term “reader” it is meant to include, without limitation, a player. Examples are CD and DVD readers.

Digital Recording Medium: a medium of any geometric shape (not necessarily circular) that is capable of storing information in digital form thereon. Digital recording medium includes, without limitation, CD, DVDs, HD-DVDs, electromagnetic tape and disks, flash drives and Optical Medium. Information stored on the medium may include, without limitation, software programs, software data, audio files and video files.

Digitizing: Conversion of non-textual data to digital form.

EMV: A standard or specification endorsed by Mastercard or Visa.

Electronic Purse: A value program stored on a card that contains one or more semiconductor chip.

Embossing: Characters in relief on the front surface of a card.

Encoding: Recording electronic information.

Encryption: Transferring information based on a key to make it intelligible to unauthorized parties.

Financial Hologram Card: Financial cards using a hologram. These cards include ISO cards, Mastercards/Visa and others.

Financial Non-Hologram Card: Financial card not using a hologram such as Debit, Check, Charge or ATM cards not using a hologram.

GSM: Global System for Mobile Communication, a widely used digital mobile phone standard.

Gift Card: A retail prepaid card usually initiated at cash or checkout.

Hologram: A flat optical image which looks three-dimensional to the naked eye.

Holographic foil: the foil used to carry embossed holographic images.

Card Chip Initialization: Programming a card chip with data that is the same for a batch of cards.

Financial ID Card: A card which identifies both the bearer and the issuer. All financial transaction cards are Financial ID cards.

ISO:=International Standards Organization, a central body for formation and dissemination of industry standards for all national standards bodies.

Identification Card Issuer: An individual or organization that issues identification cards to individual or corporate cardholders.

Lithography:=Offset Printing: A printing process for substrates based on the concept that oil and water are not compatible. The ink represents the oil and the alkaline fountain solution represents the water. These are the two main components which must interact during the printing process, allowing the ink to adhere to the image area of a printing plate while the fountain solution repels the ink from the non-image area.

Lamination: The fusing of two or more planes of material together, as for example, pressing to fuse the various layers of a plastic card together.

Light-Activated State-Change Material: is a State-Change Material that alters a measurable state function upon application of a wavelength, or subwavelength, of light or application of photonic energy to the material.

Loyalty Card: A retail frequent user card offering promotional benefits.

Optical Medium: a medium of any geometric shape (not necessarily circular) that is capable of storing indicia or content that may be read by an optical reader.

Optical Reader: a Reader (as defined below) for the reading of Optical Medium.

Permanent State-Change Material: a State-Change Material that once activated to change a measurable state function upon application of energy to the material, stays in such state permanently or for a prolonged period of time.

Magnetic Stripe: A strip of magnetic recording material such as found on many ID cards.

Membership Card: A card demonstrating participation in club. A membership card may be a club member card for ID purpose.

Multi-application Smart Card: A smart card that can handle a variety of applications.

Non-magnetic Strip Cards: Cards without a magnetic stripe.

Oersted: The unit of magnetic coercive force used to define difficult of erasure of magnetic material.

Off-line: A transaction via paper, or via a reader not connected to a central system.

On-line: A transaction on a terminal permanently connected to a network, for example, that is on-line to the card account.

Optical Card: Card with information recorded optically, e.g., compact disks.

Other Secure Card: Cards such as Retail, Oil/Gas, Telecom, Transit, Pay TV cards.

Pay TV Card: Usually a chip card subscribing to a television service eg. satellite TV.

Personalization of a Chip Card: Printing, encoding and programming a card with data specific to an individual cardholder.

Prepaid Card: A card paid for at point of sale permitting the holder to buy goods and services up to the prepaid value.

Promotional Card: A card offering special benefits to users eg, discount card.

Proximity Card: A contactless card whose presence and data can be sensed by an interface device not in physical contact with the card.

PVC:=Polyvinyl chloride, a widely used plastic material for ID cards.

Radio Frequency Card (RFID): A proximity card in which the coupling between the card and the interface device is by radio.

Secure Card: Cards having security features. Such cards may have an intrinsic value eg. financial, other secure etc.

Screen Printing: Method in which ink is forced through a design-bearing screen made of silk or other material onto the substrate being printed.

Signature Panel: The area of a card where the cardholder enters a signature.

SIM:=Subscriber Identification Module. The SiM of a smart card, for example, may be necessary for the operation of GSM phones.

Skimming: Copying the magnetic stripe encoding from one card to another.

Smart Card (aka Chip Card, IC Card): A plastic credit card sized card that contains one or more semiconductor chips. In the capability category, there are three types: Memory Card Smart Card: a smart card that stores and retrieves serial “streams” of data that are sent to or received from the semiconductor chip.

Protected Memory Smart Card: A smart card that requires a secret code or PIN number to be entered before the data can be sent to or received from the semiconductor chip.

Microprocessor Smart Card: A smart card that contains a microprocessor chip with a microcode that defines a command structure, a data file structure and a security structure in the card.

Stored Value Card (aka Cash card, Electronic purse, Prepaid card): A financial card that is loaded with a certain amount of money or value with each purchase amount deducted from the card.

State-Change Material: a material capable of altering a measurable property of the material upon activation of the material by application of energy to the material. By “state change material” it is meant to include, without limitation, materials that change in optical state (e.g., opacity and/or color) upon application of energy to the materials, materials that change in electromagnetic state (e.g., electroconductive state) upon application of energy to the materials, and materials that change in physical state (e.g. crystalline to non-crystalline structure) upon application of energy to the material.

Temporary State-Change Material: a State-Change Material that, once activated to change a measurable property of the material upon application of energy to the material, stays in such state for a period of time less than a year.

Transient State-Change Material: a State-Change material that, once activated to change a measurable property of the material spontaneously in a short period of time (minutes or less), loses such change in the measurable property. It includes, without limitation, materials that move from a first state to a second state upon application of energy, and back to the first state without application of energy.

Transportable Digital Recording Medium: a relatively small medium capable of being transported by hand from one location to another. It includes, without limitation, an optical disc, a floppy disk, a flash drive.

Transit Card: A card, such as a magnetic or chip card, used for transportation services eg. subway card.

Telecom Card: A card, such as a magnetic or chip card, used for telephone services eg. GSM card, prepaid card.

Traditional Card: A magnetic or non magnetic card not using chip card technology.

UV Printing: A type of printing wherein UV light is used to dry specially formulated inks that are printed. In conventional printing, ink dries as it is absorbed into paper. Because plastic is not absorbent, the ink may be dried on the top surface using UV light.

Weigand Wire: Magnetic media embedded in cards for access control applications

For the purpose of the rest of the disclosure, it is understood that the terms as defined above are intended, whether such terms are in all initial cap or not.

### SUMMARY OF THE INVENTION

The present invention provides for a piracy protected transportable digital recording medium that is readable on a digital reader.

In an embodiment, such the digital recording medium has incorporated thereon a polymeric film comprising an authentication material which is necessary for read or full read of the digital recording medium. Such film may comprise a polycarbonate film with matched characteristics for read purposes to the underlying substrate. Such film may comprise for example, EUROPLEX PC, and may be of a gauge of about 405, or may be a film such as used to protect Blu-ray discs from environmental damage such as scratches. The film may be used as a cover layer to protect from environmental damage the digital data recorded on the digital recording medium. The film may comprise one material layer, or may comprise two or more layers such as a rigid polycarbonate layer and a flexible layer based on polyurethane, and may comprise a laminate structure. The authentication material associated with the film may be any material a property of which is detectable by the digital reader. Directions for the digital reader to search out such materials may be provided, as for example, by way of software associated with the digital recording medium and/or the digital reader, or by hardwire of the digital reader or a device associated therewith. The authentication material may comprise a state change material that changes state in a manner detectable by the digital reader upon application of an energy source, such as the reading laser of the reader or an external source.

In another embodiment, there is provided a digital recording medium that has associated therewith a polymeric film that contains electronic components incorporated therein. Such electronic components may comprise, for example, without limitation, circuitry and/or a chip, that elicits a response to an activation source directed thereat. In such embodiment, the response produced is detectable by the reader, and if the response is within predetermined values, the digital recording medium is authenticated.

In yet another embodiment, there is provided a digital recording medium that has associated therewith a film that containing a degradable state change material such as a temporary state change material that is need for authentication and which is removed when the digital recording medium is attempted to be read on an unauthorized digital reader. Such digital recording medium may include a machine locking software which permits its read on only certain machines. If an unauthorized machine is used to read the digital recording medium, software on the digital recording medium may be directed to remove the degradable authentication material.

The digital recording medium of such embodiments may include, without limitation, a CD, DVD, telecom card, transit card, proximity card, prepaid card, pay TV card, optical card, loyalty card, financial hologram or non-hologram card, electronic purse card, or Smart Card. The film may be applied anywhere on or in the cards, but may preferably be applied to at least one surface to protect the card from environmental damage.

### DETAILED DESCRIPTION OF THE INVENTION

The present invention provides for the protection of digital recording media storing digital information from piracy and allows authentication of the media on an authorized system.

In a first embodiment, the digital recording media is coated at least on one surface with an oligomer film containing an authentication material, the film being cross-linked to the media by UV cross-linking. The film, for example, may be a Blu-Ray type film, and the media may be, for example, a CD or DVD. Media may be authenticated on-line with the machine-locking software, and the media may be serialized by techniques known in the art before being packaged and shipped to an end user.

In another embodiment, the digital recording media is coated at least on one surface with an oligomer film that contains a dye which is detectable by locking software/hardware on the medium or associated with the reader. For example, with respect to a CD, the authentication film may contain an approximately 780 nm activatable dye system which provides at least one physical attribute that the locking software in conjunction with the reading system may identify.

In yet another embodiment, the authentication oligomer film on the digital recording medium contains a thermochromic dye that is reacts to the temperature of about 98° F. The medium may require that a human finger be placed over an area where such thermochromic dye is found to form a pressed finger print. The locking software that may be incorporated onto the medium (and/or incorporated into the reader system) may be designed to authenticate the card only upon receipt of the correct pressed finger print.

In yet another embodiment, electro-optical components are added to the film stock to provide authenticating structure, or structure designed to improve authentication. For example, the electronic component in the film may provide a radio frequency identification device antenna, and such may be printed onto the film stock before ultra-violet cross linking of the material to the digital recording medium, such as CD-R card stock. Electronic components may be made, for example, by application of Mitsubishi Kagaku Media patented metal azo. Electro-optical components may be passive or active and may include, for example, without limitation, radio frequency ID (RFID), electronic circuits, chips, microprocessors, transistors, light emitting diodes, integrated circuits, amplifiers, oscillators, diodes, capacitors, resistors, and inductors.

In yet another embodiment, there is provided a film that contains authentication material that can be degraded by an activation source, such as the reader laser. In such embodiment, the authentication material may be necessary for the digital recording medium to be read fully, or more fully, given the locking software associated with the system. However, the medium may include software that is directed to ablate, or alter the authentication material in a way that it is no longer detectable by the system, if the medium does not present as an authenticate medium. For example, the software may remove an authentication ring by inducing a permanent photo bleach that renders the security system inactive.

The digital recording medium may be of any material. However if the medium is polycarbonate-based, the authentication film may also be preferably polycarbonate-based such that the film itself does not affect read. The material of the medium may include, without limitation, ABS or PVC. The Digital recording medium may be, without limitation, an access control card, a card having measurable coercivity, a combi-card, a contact card, a contactless card, an electronic purse card, a financial hologram card, a financial other card, a gift card, an ID card, an optical disc, a loyalty card, a magnetic stripe card, a non-magnet card, an optical card, a secure card, a pay tv card, a prepaid card, a promotional card, a proximity card, a radio frequency card, a smart card, a stored value card, a transit card, a telecom card, or traditional card. The medium may include numerous attributes, such as, without limitation, UV printing thereon, a weigand wire therein, a SIM, SET standard technology, a signature panel, personalization indicia, magnetic stripes, ISO standard technology, holographics, GSM standard technology, EMV standard technology, read contacts, and chips.

The film may be associated with authentication material before it is attached to the digital recording medium, such as by UV cross-linking. The authentication material may be incorporated directly into the film or may be printed thereon as by lithography/offset printing, screening printing, or other printing techniques known in the art. Besides being useful in the authentication process, the film may provide cover against environmental damages (such as scratching) in lieu of materials such as lacquer which may be used on CDs and DVDs. The authenticating material may be applied in a coating, and the coating can be placed on the film first, and the film subsequently bonded to the digital recording medium. Such method/process, for example, may deliver a low cost security component to square and rectangular optical devices without the need for a lacquer coat.

Such embodiments may be directed to any field of secure data, including banking transmission, and may involve many kinds of electronic based memory devices, as well as optical media such as CD-/R, DVD-/R/W, HD-DVD-/R, Blu-Ray-/R/Terabyte-Holographic data storage medium, and similar media.

The authentication film may comprise one layer, or two or more layers, including laminates. The film may be a Blu-ray film such as, without limitation, a thin gauge polycarbonate EUROPLEX PC of about 405, which with regard to polycarbonate-based optical medium may be found to produce dimensional stability (skew resistance), low birefringence (IR matched to polycarbonate), high impact strength, and high stiffness (tensile modulus of about 2,300 MPa). The film may comprise one or more layers in a multi-layer medium, such as a multi-layer banking card.

### Statement Regarding Preferred Embodiments

While the invention has been described with respect to preferred embodiments, those skilled in the art will readily appreciate that various changes and/or modifications can be made to the invention without departing from the spirit or scope of the invention as defined by the appended claims. All documents cited herein are incorporated by reference herein where appropriate for teachings of additional or alternative details, features and/or technical background.

We claim:

1. A piracy protection digital recording medium comprising an optical recording medium coated with a polymeric film containing authentication state change material therein, the authentication state change material being readable by a digital reader of such optical recording medium.

2. A piracy protection digital recording medium in claim 1 wherein the authentication state change material is an approximately 780 nm activatable dye system.

3. A piracy protection digital recording medium in claim 1 wherein the authentification state change material comprises a thermochromic dye that reacts to the temperature of about 98° F.

4. A piracy protection digital recording medium in claim 3 wherein the authentification state change material is a thermochromic dye in a concentration sufficient to permit activation by a human finger and recording at least a portion of a human finger print.

5. A digital recording medium in claim 1 selected from the group consisting of: an access control card, a card having measurable coercivity, a combi-card, a contact card, a contactless card, an electronic purse card, a financial hologram card, a financial other card, a gift card, an ID card, an optical disc, a loyalty card, a magnetic stripe card, a non-magnet card, an optical card, a secure card, a pay tv card, a prepaid card, a promotional card, a proximity card, a radio frequency card, a smart card, a stored value card, a transit card, a telecom card, a multi-layer banking card, and a traditional card.

6. A digital recording medium in claim 1 further comprising at least one of the group consisting of: UV printing, weigand wire, a SIM, SET standard technology, a signature panel, personalization indicia, a magnetic stripe, ISO standard technology, holographic, GSM standard technology, EMV standard technology, a read contact, and a chip.

7. An optical recording medium in claim 1 selected from the group consisting of: a CD, CD-/R, DVD-/R/W, HD-DVD-/R, and Blu-Ray-/R/Terabyte Holographic data storage medium.

8. A piracy protection digital recording medium of claim 1 wherein the polymeric film comprises one layer.

9. A piracy protection digital recording medium of claim 1 wherein the polymeric film comprises a plurality of layers.

10. A piracy protection digital recording medium of claim 9 wherein the polymeric film comprises a laminate.

11. A piracy protection digital recording medium of claim 1 wherein the polymeric film is a thin gauge polycarbonate EUROPLEX PC film.

12. A piracy protection digital recording medium of claim 1 comprising electro-optical components selected fiom the group consisting of a radio frequency ID (RFID), an electronic circuit, a chip, a microprocessor, a transistor, a light emitting diode, an integrated circuit, an amplifier, an oscillators, a diode, a capacitor, a resistor, and an inductors.

13. A method of providing piracy protection for digital recording medium comprising coating the digital recording medium with a polymeric film containing an authentication state change material therein.

14. A method of providing piracy protection for digital recording medium in accord with claim 13 wherein the authentication state change material is an approximately 780 nm activatable dye system.

15. A method of providing piracy protection for digital recording medium in accord with claim 13 wherein the authentication state change material is a thermochromic dye that reacts to temperature of about 98° F.

16. A method of providing piracy protection for digital recording medium in accord with claim 15 wherein the authentication state change material is at a concentration sufficient to permit activation by a human finger and capable of recording at least a portion of a human finger print.

17. A method of providing piracy protection for digital recording medium in accord with claim 13 wherein the digital recording medium is selected from the group consisting of an access control card, a card having measurable coercivity, a combi-card, a contact card, a contactless card, an electronic purse card, a financial hologram card, a financial other card, a gift card, an ID card, an optical disc, a loyalty card, a magnetic stripe card, a non-magnet card, an optical card, a secure card, a pay tv card, a prepaid card, a promotional card, a proximity card, a radio frequency card, a smart card, a stored value card, a transit card, a telecom card, a multi-layer banking card, and a traditional card.

18. A method of providing piracy protection for digital recording medium in accord with claim 13 wherein the digital recording medium to be coated contains at least one of the group consisting of UV printing, weigand wire, a SIM, SET standard technology, a signature panel, personalization indicia, a magnetic stripe, ISO standard technology, holographic, GSM standard technology, EMV standard technology, a read contact, and a chip.

19. A method of providing piracy protection for digital recording medium in accord with claim 13 wherein the digital recording medium is selected fiom the group consisting of a CD, CD-/R, DVD-/R/W, HD-DVD-/R, and Blu-Ray-/R/Terabyte Holographic data storage medium.

20. A method of providing piracy protection for digital recording medium in accord with claim 13 wherein the polymeric film is a thin polycarbonate EUROPLEX PC film.

21. A method of providing piracy protection for digital recording medium in accord with claim 13 wherein incorporated in the polymeric film includes at least one electro-optical component selected from the group consisting of: radio frequency ID (RFID), an electronic circuit, a chip, a microprocessor, a transistor, a light emitting diode, an integrated circuit, an amplifier, an oscillator, a diode, a capacitor, a resistor, an inductor, and a passive component.
